(19) United States
(12) Patent Application Publication
(10) Pub. No.: US 2026/0348076 A1
(43) Pub. Date: Nov. 5, 2026

(54) Laundry Control Method and Laundry Apparatus Capable of Automatically Hanging Clothes

(71) Applicants: SHENZHEN YIMU TECHNOLOGY CO., LTD., Shenzhen, Guangdong (CN); NANJING YIMU INTELLIGENT TECHNOLOGY CO., LTD,, Nanjing, Jiangsu (CN)

(72) Inventor: Hongyi Li, Shenzhen, Guangdong (CN)

(21) Appl. No.: 19/135,635

(22) PCT Filed: Dec. 12, 2023
(86) PCT No.: PCT/CN2023/138020

§ 371 Date: Jun. 3, 2026

(30) Foreign Application Priority Data
Dec. 14, 2022 (CN) 202211607521.4
Dec. 8, 2023 (CN) 202311692782.5

(51) Int. Cl. D06F 58/04; D06F 34/14; D06F 105/46

(52) U.S. Cl. CPC D06F 58/04; D06F 34/14; D06F 2105/46

(57) ABSTRACT

Disclosed are a laundry control method and laundry apparatus capable of automatically hanging clothes. The laundry control method comprises: a main control board sends a rotation instruction to a drum driving motor to drive a drum to rotate until a gripping apparatus is at a lowest point, and clothes fall onto a wall of the drum under action of gravity; the main control board sends a gripping instruction to the gripping apparatus to change it into a working state to grip clothes inside the drum; a gripping sensor sends a gripping signal to the main control board in real time; the gripping apparatus keeps the gripping state after gripping; the main control board sends the rotation instruction to the drum driving motor to drive the drum to rotate until the gripping apparatus is located at a highest point, and the clothes are vertically hung under action of gravity.

### TECHNICAL FIELD

The present disclosure relates to the field of washing machines, and in particular to, a laundry control method and a laundry apparatus capable of automatically hanging clothes.

### BACKGROUND

Currently, there are many problems as follows with washing machines on the market that users encounter during use: (1) the washing machine has a drying function, but has no custodian care function; after the clothes are washed, the clothes are clumped together and it is difficult to fully dry them after the drying function ends, and the clothes that users get in the end are often still damp; (2) for the washing machine with a custodian care function, the washing machine requires continuous heating and rotation of the drum to dry the clothes since the clothes are clumped together, which lasts for a long time and results in significant electricity cost for users; in addition, the constant rolling of the clothes may easily cause wear, shortening the service life of the clothes; (3) since the clothes are clumped together, the efficiency of the ultraviolet sterilization lamp decreases, the sterilization lamp can only irradiate exposed parts of the clumped clothes for a short time, and most of the clothes are not directly exposed to light, resulting in poor sterilization effect and failure to meet the actual sterilization needs of users. In addition, an existing sterilization or drying apparatus with a clothes hanging function adopts a specialized sterilization or drying area. When sterilization and drying need to be moved to a designated area, the overall process is complicated, which is not conducive to achieving fully automatic clothes hanging and energy saving.

### SUMMARY

Technical purposes: aiming at the above technical problems, the present disclosure provides a laundry control method and a laundry apparatus capable of automatically hanging clothes, which can achieve internal hanging of clothes in the laundry apparatus, and solve the problems of clothes entanglement and poor sterilization and drying effects without damaging the clothes.

Technical solutions: in order to realize the above technical purposes, the present disclosure adopts the following technical solutions:

A laundry control method capable of automatically hanging clothes, applied to a laundry apparatus, the laundry apparatus being provided with a tub, a drum, a drum driving motor, and a main control board, the drum being provided with a gripping apparatus, the gripping apparatus having a highest point and a lowest point in a vertical direction when rotating with the drum, the gripping apparatus being provided with a gripping sensor;
the laundry control method including a clothes hanging program, the clothes hanging program including the steps of:
sending, by the main control board, a rotation instruction to the drum driving motor, so that the drum driving motor drives the drum to rotate until the gripping apparatus is at the lowest point, and clothes fall onto a wall of the drum under the action of gravity;
sending, by the main control board, a gripping instruction to the gripping apparatus, so that the gripping apparatus grips the clothes inside the drum, and the gripping sensor returns a gripping signal to the main control board in real time; if the main control board determines that the gripping signal returned this time indicates gripping failure, the main control board resets the gripping apparatus to repeat the gripping operation, the gripping operation is stopped until the main control board determines that a gripping signal returned this time indicates gripping success, and the gripping apparatus maintains a gripping state; if the main control board determines that a gripping signal returned this time indicates gripping success, the gripping operation is stopped, and the gripping apparatus maintains a gripping state;
sending, by the main control board, a rotation instruction to the drum driving motor, so that the drum driving motor drives the drum to rotate until the gripping apparatus is at the highest point, and the clothes are hung vertically under the action of gravity at this time, completing automatic clothes hanging.

In some embodiments, the gripping signal is determined by the following method:
the gripping apparatus includes at least one pair of grippers, the grippers partially or entirely consist of conductive metal sheets, a distance detection method is used to detect the distance between the two grippers, if there are clothes between the grippers and the metal sheets are spaced apart by the clothes, a gripping signal “1” indicating gripping success is outputted, if there are no clothes between the grippers and the conductive metal sheets are attached, a gripping signal “0” indicating gripping failure is outputted;
or
the gripping apparatus includes at least one pair of grippers, a light signal detection method is used to detect whether there is obstruction between the two grippers, when there are no clothes between the grippers, the gripping signal is data of a fixed value, when there are clothes between the grippers, the gripping signal is data of a varying value.

In some embodiments, the laundry control method includes a sterilization and drying program, and the sterilization and drying program includes 1 or more than 1 clothes hanging program, and the sterilization and drying program ends until it is detected that any one or both of temperature and humidity inside the drum are lower than set values within a first preset time.

In some embodiments, after the sterilization and drying program ends, if a door of a washing machine is not opened within a second preset time, a new round of sterilization and drying program automatically starts.

In some embodiments, the laundry control method includes a spinning program, and the clothes hanging program is executed before entering the sterilization and drying program after the spinning program is completed, or the clothes hanging program is executed in the sterilization and drying program.

A laundry apparatus capable of automatically hanging clothes, the laundry apparatus being provided with a tub, a drum, a drum driving motor, and a main control board, the drum being provided with a gripping apparatus and a position sensor, wherein the gripping apparatus is configured to grip clothes inside the drum, the gripping apparatus has a highest point and a lowest point in a vertical direction when rotating with the drum, the position sensor is configured to send current position information of the gripping apparatus to the main control board, the gripping apparatus is provided with a gripping sensor, and the gripping sensor is configured to send a gripping signal indicating a result of gripping by the gripping apparatus to the main control board in real time.

In some embodiments, the gripping apparatus includes at least one pair of grippers, the grippers consist of metal sheets, the gripping sensor is a distance sensor for detecting whether there are clothes between the two grippers of each mechanical gripper, if there are clothes between the grippers and the metal sheets are spaced apart by the clothes, a gripping signal indicating gripping success is outputted, and if there are no clothes between the grippers and the metal sheets are attached, a gripping signal indicating gripping failure is outputted.

In some embodiments, the gripping apparatus includes at least one pair of grippers, the gripping sensor includes a light signal transmitting device arranged on one gripper, a light signal receiving device arranged on the other gripper, the light signal receiving device is configured to send a gripping signal to the main control board, when there are no clothes between the grippers, the gripping signal is data of a fixed value, and when there are clothes between the grippers, the gripping signal is data of a varying value.

In some embodiments, the drum of the laundry apparatus is further provided with a sterilization apparatus, a drying apparatus, and any one or two of a temperature sensor and a humidity sensor.

In some embodiments, the drum of the laundry apparatus is provided with a drum rib protruding out of an inner surface wall, and the gripping apparatus is located between the drum rib and an inner wall of the drum.

A laundry control method capable of automatically hanging clothes, applied to a laundry apparatus, the laundry apparatus being provided with a tub, a drum, a drum driving motor, and a main control board, the drum being provided with a gripping apparatus, the gripping apparatus having a highest point and a lowest point in a vertical direction when rotating with the drum, the gripping apparatus being provided with a position detection module;
the laundry control method including a clothes hanging program, the clothes hanging program including the following steps:
sending, by the main control board, a rotation instruction to the drum driving motor, so that the drum driving motor drives the drum to rotate until the gripping apparatus is at the lowest point, and clothes fall onto a wall of the drum under the action of gravity, where the lowest point is obtained through the position detection module;
sending, by the main control board, a gripping instruction to the gripping apparatus, so that the gripping apparatus grips the clothes inside the drum; and
sending, by the main control board, a rotation instruction to the drum driving motor, so that the drum driving motor drives the drum to rotate until the gripping apparatus is at the highest point, and the clothes are hung vertically under the action of gravity at this time, completing automatic clothes hanging, where the highest point is obtained through the position detection module.

In some embodiments, after the step of sending, by the main control board, a rotation instruction to the drum driving motor, so that the drum driving motor drives the drum to rotate until the gripping apparatus is at the highest point, the laundry control method further includes the following steps:
sending, by the main control board, a release instruction to the gripping apparatus; returning to the step of sending, by the main control board, a rotation instruction to the drum driving motor, so that the drum driving motor drives the drum to rotate until the gripping apparatus is at the lowest point; and continuing to perform gripping.

In some embodiments, before the step of sending, by the main control board, a release instruction to the gripping apparatus, the laundry control method further includes the following steps:
counting, by the main control board, the number of gripping times of the gripping apparatus;
determining, by the main control board, whether the number of gripping times of the gripping apparatus reaches a preset number of times;
if the main control board determines that the number of gripping times of the gripping apparatus does not reach the preset number of times, sending, by the main control board, a release instruction to the gripping apparatus; returning to the step of sending, by the main control board, a rotation instruction to the drum driving motor, so that the drum driving motor drives the drum to rotate until the gripping apparatus is at the lowest point; continuing to perform gripping; and
if the main control board determines that the number of gripping times of the gripping apparatus reaches the preset number of times, sending a rotation stop instruction to the drum driving motor.

In some embodiments, the step of sending, by the main control board, a rotation instruction to the drum driving motor, so that the drum driving motor drives the drum to rotate until the gripping apparatus is at the lowest point further includes the following steps:
when the drum driving motor drives the drum to rotate until the gripping apparatus is at the lowest point, controlling, by the main control board, the drum driving motor to continue rotating; and
when the main control board receives a signal returned by the drum driving motor indicating the completion of a preset number of rotations, sending, by the main control board, a rotation instruction to the drum driving motor, so that the drum driving motor drives the drum to rotate until the gripping apparatus goes back to the lowest point.

In some embodiments, the step of sending, by the main control board, a rotation instruction to the drum driving motor, so that the drum driving motor drives the drum to rotate until the gripping apparatus is at the lowest point further includes the following steps:
sending, by the main control board, an instruction of multiple forward and reverse rotations to the drum driving motor; and
after the main control board receives a signal returned by the drum driving motor indicating the completion of multiple forward and reverse rotations, sending, by the main control board, a rotation instruction to the drum driving motor, so that the drum driving motor drives the drum to rotate until the gripping apparatus goes back to the lowest point.

In some embodiments, the step of sending, by the main control board, a rotation instruction to the drum driving motor, so that the drum driving motor drives the drum to rotate until the gripping apparatus is at the lowest point further includes the following steps:
when the main control board detects that the gripping apparatus is at the lowest point, sending a low-speed rotation instruction to the drum driving motor; and
if the main control board receives a low-speed rotation signal returned by the drum driving motor, sending a gripping instruction to the gripping apparatus.

In some embodiments, after the step of sending, by the main control board, a rotation instruction to the drum driving motor, so that the drum driving motor drives the drum to rotate until the gripping apparatus is at the highest point, the laundry control method further includes the following steps:
counting, by the main control board, the time spent by the gripping apparatus in hanging the clothes; and
if the main control board detects that the time spent by the gripping apparatus in hanging the clothes reaches preset time, sending a release instruction to the gripping apparatus.

In some embodiments, after sending a release instruction to the gripping apparatus, the laundry control method further includes the following steps: returning to the step of sending, by the main control board, a rotation instruction to the drum driving motor, so that the drum driving motor drives the drum to rotate until the gripping apparatus is at the lowest point; and continuing to perform the clothes hanging program.

In some embodiments, the automatic clothes hanging program is executed before entering a drying program, or the automatic clothes hanging program is executed in the drying program.

In some embodiments, the drying program includes at least one automatic clothes hanging program, and the drying program ends until it is detected that temperature and/or humidity inside the drum are lower than set values within preset time.

In some embodiments, the drying program further includes a sterilization program and/or an aroma care program and/or a fresh air program and/or a warm air program.

In some embodiments, after the drying program ends, if a door of a washing machine is not opened within preset time, a new round of drying program automatically starts.

In some embodiments, the automatic clothes hanging program is executed after a drying program is completed.

In some embodiments, after the step of sending, by the main control board, a rotation instruction to the drum driving motor, so that the drum driving motor drives the drum to rotate until the gripping apparatus is at the highest point, the laundry control method further includes the following step:
starting up, by the main control board, a sterilization program and/or an aroma care program and/or a fresh air program and/or a warm air program and/or a plasma program.

In some embodiments, the laundry control method further includes the following step:
sending, by the main control board, an automatic clothes hanging instruction to control a power supply circuit of the gripping apparatus to be conducted.

A laundry apparatus capable of automatically hanging clothes, configured to implement the laundry control method capable of automatically hanging clothes described above, the laundry apparatus being provided with a tub, a drum, a drum driving motor, and a main control board, the drum being provided with a gripping apparatus and a position sensor, where the gripping apparatus is configured to grip clothes inside the drum, the gripping apparatus has a highest point and a lowest point in a vertical direction when rotating with the drum, and the position sensor is configured to send current position information of the gripping apparatus to the main control board.

In some embodiments, the gripping apparatus includes at least one pair of grippers.

In some embodiments, the drum of the laundry apparatus is further provided with a sterilization apparatus and/or an aroma care apparatus, and any one or two of a temperature sensor and a humidity sensor.

In some embodiments, the drum of the laundry apparatus is provided with a drum rib protruding out of an inner surface wall, and the gripping apparatus is located between the drum rib and an inner wall of the drum.

Beneficial effects: by adopting the above technical solutions, the present disclosure has the following beneficial effects:

The laundry control method and the laundry apparatus capable of automatically hanging clothes provided in the present disclosure can execute the automatic clothes hanging program and the sterilization and drying program, achieve automatic clothes hanging, improve the sterilization effect and the drying efficiency, and achieve high automation level.

### BRIEF DESCRIPTION OF THE DRAWINGS

FIG. 1 is a flowchart of a laundry control method capable of automatically hanging clothes provided in Embodiment 1.

FIG. 2 is a schematic structural diagram of a laundry apparatus capable of automatically hanging clothes provided in Embodiment 2.

FIG. 3 is a schematic structural diagram when a metal conductive rod and a conductive ring are not conducted in FIG. 2.

FIG. 4 is a schematic structural diagram when a metal conductive rod and a conductive ring are conducted in FIG. 2.

FIG. 5 is a schematic structural diagram when a drum rotates to a lowest point in FIG. 2.

FIG. 6 is a schematic structural diagram when a drum rotates to a highest point in FIG. 2.

FIG. 7 is a comparison chart of drying situations under a standard-cloth standard mode and a hanging mode provided in the present disclosure.

FIG. 8 is a flowchart of a laundry control method capable of automatically hanging clothes provided in Embodiment 3.

FIG. 9 is a flowchart of multiple-gripping control in Embodiment 3.

FIG. 10 is a flowchart of multiple-gripping and multiple-release control in Embodiment 3.

FIG. 11 is a flowchart of gripping control after rotation of a drum in Embodiment 3.

FIG. 12 is a flowchart of gripping control after multiple forward and reverse rotations in Embodiment 3.

FIG. 13 is a flowchart of gripping control of multiple gripping apparatuses during rotation in Embodiment 3.

FIG. 14 is a flowchart of gripping control during low-speed rotation of a drum in Embodiment 3.

FIG. 15 is a flowchart of corresponding fresh air maintaining after an automatic clothes hanging program is executed after a drying program is completed in Embodiment 3.

Description of reference signs: 1—contact motor, 2—metal conductive rod, 3—bracket, 4—driving motor, 5—temperature sensor, 6—drum, 7—tub, 8—tripod, 9—gripping apparatus, 10—position sensor, 11—drum rib, and 12—clothes

### DETAILED DESCRIPTION

The following describes the embodiments of the present disclosure in detail with reference to the accompanying drawings.

### Embodiment 1

This embodiment provides a washing machine control system capable of automatically hanging clothes, which includes, but not limited to, an automatic clothes hanging program and a sterilization and drying program. After the clothes are washed and spun in a drum of a washing machine, the automatic clothes hanging program and the sterilization and drying program automatically start.

Specifically, a laundry control method includes a clothes hanging program, and the clothes hanging program includes the following steps:
a main control board sends a rotation instruction to a drum driving motor, so that the drum driving motor drives a drum to rotate until a gripping apparatus is at a lowest point, and clothes fall onto a wall of the drum under the action of gravity;
the main control board sends a gripping instruction to the gripping apparatus, so that the gripping apparatus grips the clothes inside the drum, and the gripping sensor returns a gripping signal to the main control board in real time; if the main control board determines that the gripping signal returned this time indicates gripping failure, the main control board resets the gripping apparatus to repeat the gripping operation, the gripping operation is stopped until the main control board determines that a gripping signal returned this time indicates gripping success, and the gripping apparatus maintains a gripping state; if the main control board determines that a gripping signal returned this time indicates gripping success, the gripping operation is stopped, and the gripping apparatus maintains a gripping state.

The main control board sends a rotation instruction to the drum driving motor, so that the drum driving motor drives the drum to rotate until the gripping apparatus is at the highest point, and the clothes are hung vertically under the action of gravity at this time, completing automatic clothes hanging.

The gripping signal is determined by the following method:

The gripping apparatus includes at least one pair of grippers, the grippers partially or entirely consist of conductive metal sheets, a distance detection method is used to detect the distance between the two grippers, if there are clothes between the grippers and the metal sheets are spaced apart by the clothes, a gripping signal “1” indicating gripping success is outputted, and if there are no clothes between the grippers and the conductive metal sheets are attached, a gripping signal “0” indicating gripping failure is outputted.

Alternatively,
the gripping apparatus includes at least one pair of grippers. A light signal detection method is used to detect whether there is obstruction between the two grippers. When there are no clothes between the grippers, the gripping signal is data of a fixed value. When there are clothes between the grippers, the gripping signal is data of a varying value.

### Embodiment 2

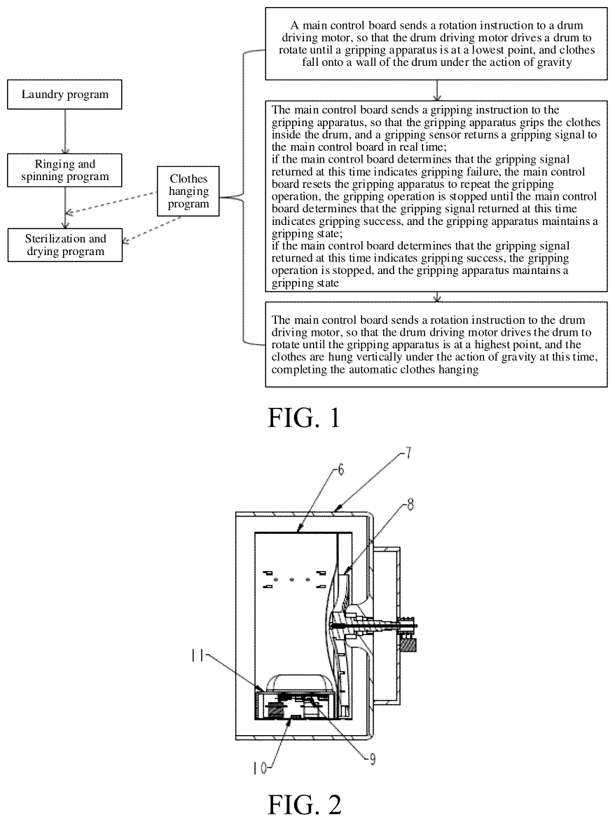

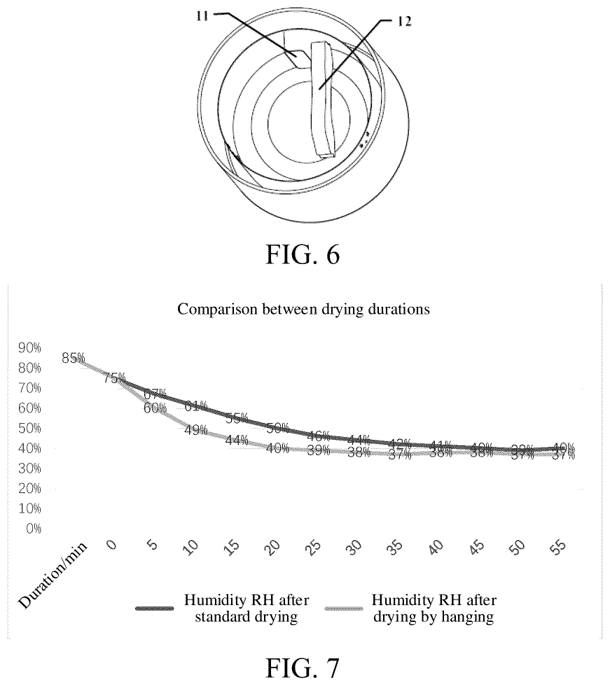

Referring to FIG. 1 to FIG. 6, this embodiment provides a laundry apparatus capable of automatically hanging clothes, which includes, but not limited to, a contact motor, a metal conductive rod, a conductive ring, a bracket, a motor, a tripod, a tub, a drum, a drum rib, a gripping apparatus, a position sensor, a humidity sensor, and a temperature sensor. The metal conductive rod is fixed onto the contact motor. The position sensor and the gripping apparatus are mounted in the same drum rib of the washing machine.

The laundry apparatus executes the automatic clothes hanging program and the drying and sterilization program described above.

Specifically, the automatic clothes hanging program includes the following steps:
(1) After a washing machine completes spinning, a main control board sends an automatic clothes hanging instruction to control the contact motor to move a specified distance towards the conductive ring.
(2) The metal conductive rod on the contact motor and the conductive ring establish circuit conduction. An ultraviolet lamp, the gripping apparatus and the position sensor mounted inside the drum rib are powered on, and stay in a standby state.
(3) After the contact motor completes the displacement of the specified distance, a displacement signal is fed back to the main control board, and the main control board controls the driving motor to rotate clockwise/anticlockwise at low speed.
(4) The position sensor starts working and continuously transmits a current position signal to the main control board. When the position sensor is at the lowest point and transmits a lowest point signal to the main control board, the main control board controls the driving motor to stop rotating. At this time, the position sensor and the gripping apparatus are at the lowest point, and the clothes fall to the lowest point due to gravity. The drum rib protrudes out of the surface of the drum. The clothes are blocked on the side of the drum rib.
(5) After a rotation stop signal of the driving motor is returned to the main control board, the main control board immediately turns on the gripping apparatus, and the gripping apparatus starts working. A gripping sensor for determining a gripping signal is provided on the gripping apparatus.
(6) When a signal returned by the gripping sensor is 0, it is determined as gripping failure, and the main control board resets the gripping apparatus to repeat a gripping operation. It is determined as gripping success until a signal returned by the gripping sensor is 1.
(7) When a signal returned by the gripping sensor is 1, the gripping apparatus maintains a gripping state, the main control board controls the driving motor to rotate, and the position sensor simultaneously returns a current position signal. When the position is at the highest point, the main control board receives a highest point signal and sends a stop instruction to control the driving motor to stop rotating. At this time, the gripping apparatus is at the highest point, and the clothes are hung vertically under the action of gravity, completing the automatic clothes hanging program.

Specifically, the sterilization and drying program includes the following steps:
(1) When the automatic clothes hanging program is completed, the main control board sends an instruction to start up the sterilization and drying program, including a sterilization program and a drying program.
(2) The main control board sends an instruction to turn on a sterilization apparatus, turn on a heating wire and a fan of a drying assembly, and simultaneously turn on the humidity sensor and/or the temperature sensor (that is, one of a separate temperature sensor, a separate humidity sensor, and a combination of a temperature sensor and a humidity sensor is turned on to detect whether the clothes have been dried). The sensors continuously return temperature and/or humidity values to the main control board. If the temperature and/or humidity values returned by the sensors are continuously less than set values for n minutes, the main control board determines that the clothes have been dried, and turns off the sterilization apparatus and drying assembly. At this time, the sterilization and drying program is completed once.
(3) Since it is difficult to dry the part of the clothes gripped by the grippers, the main control board is further provided with a time counting program. When the grippers grip the clothes for drying for set time of n minutes, the clothes are put down, and the main control board controls the gripping apparatus to rotate to the lowest point to grip the clothes from a different angle until the clothes are completely dried.
(4) After the sterilization and drying program is completed once, if the user fails to take out the clothes in a timely manner and causes moisture regain, the sterilization and drying program (2) is repeated to perform the sterilization and drying program once again. The main control board sends an instruction to turn on the sterilization apparatus, turn on the heating wire and the fan of the drying assembly, and simultaneously turn on the humidity sensor and/or temperature sensor. The sensor continuously returns the temperature and/or humidity values to the main control board. If the temperature and/or humidity values are less than the set values for n minutes again, the user opens the door of the washing machine, and the entire laundry program is completed.
(5) The sterilization apparatus includes, but not limited to, any sterilization method such as ultraviolet lamp, high temperature, ozone, and silver ions.

In this embodiment, multiple gripping apparatuses may be provided, or the gripping apparatus may be provided with multiple grippers to grip multiple pieces of clothes.

After the washing machine completes a rinsing and spinning program, the clothes are still damp after being spun. At this time, the washing machine starts to start up the clothes hanging program, and the contact motor begins to approach the conductive ring. After the contact motor moves a set distance, the metal conductive rod on the contact motor contacts the conductive ring, establishing circuit conduction at this time. Several wires are provided on an outer end of the conductive ring. The wires pass through a center hole of the conductive ring, enter an axial hole of the tripod, and then exit from the other end of the tripod to reach the area between tub and the drum of the washing machine. The wires are connected to the gripping apparatus in the drum rib to supply power to it.

After the washing machine starts to start up the clothes hanging program, the main control board controls the speed of the driving motor to be low. When the position sensor is at the lowest point, the driving motor stops rotating. Due to the action of gravity, the clothes will also be at the lowest end of the washing machine. At this time, the gripping apparatus is turned on to grip the clothes tightly. Then the driving motor is turned on, and the drum starts rotating. When the position sensor detects that it is at the highest position, the driving motor controls the drum to stop rotating. At this time, the clothes are in a vertical hanging state due to the action of gravity, completing the automatic clothes hanging operation.

The sterilization apparatus is turned on, the drying function is started up, and the area of the clothes irradiated by the sterilization apparatus is increased. During drying, the area of contact between the clothes and hot air also greatly increases, making the sterilization effect much better than that of the clothes which are clumped together and are not hung, and also making the air-drying speed of the clothes much faster than that of the clothes which are clumped together.

### Embodiment 3

This embodiment provides a laundry control method capable of automatically hanging clothes, applied to a laundry apparatus. The laundry apparatus is provided with a tub, a drum, a drum driving apparatus, and a main control board. The drum is provided with a gripping apparatus. The gripping apparatus has a highest point and a lowest point in a vertical direction when rotating with the drum. The gripping apparatus is provided with a position detection module. The drum driving apparatus includes, but not limited to, a belt pulley driven by a motor, a direct driving motor, or the like. In this embodiment, the drum driving apparatus is a drum driving motor.

The laundry control method includes a clothes hanging program, which involves the drum being configured to rotate. When the gripping apparatus is detected to be located at a gripping action execution position (in a lower area of a drum body, hereinafter referred to as the lowest point), the gripping apparatus starts to execute a gripping action. After the gripping action is completed, the drum body continuously rotates until it is detected to be located at a hanging position (in an upper area of the drum body, hereinafter referred to as the highest point), thus completing clothes hanging.

It is to be understood that the gripping apparatus may also be represented as a picking apparatus, a grasping apparatus, or a clamping apparatus, which is configured to achieve the detachment or partial detachment of the clothes to be cleaned (especially underwear) from the contact with a wall of the drum under the action of gravity.

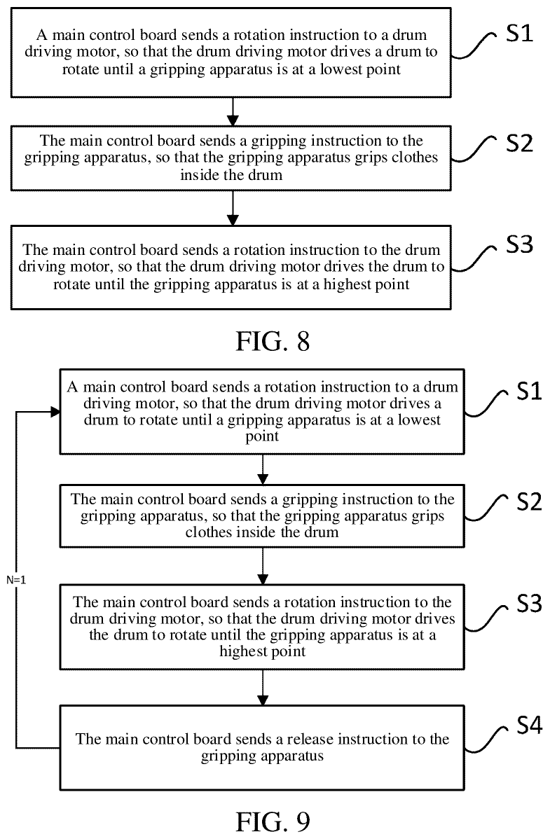

Specifically, referring to FIG. 8, the clothes hanging program includes the following steps:

In S1: The main control board sends a rotation instruction to the drum driving motor, so that the drum driving motor drives the drum to rotate until the gripping apparatus is at the lowest point, and clothes fall onto the wall of the drum under the action of the rotation inertia of the drum and the action of gravity, and are closely attached to a drum rib in which the gripping apparatus is mounted. The lowest point is obtained through the position detection module. Specifically, it is obtained by that the main control board detects a signal fed back from the position detection module. It is to be understood that in order to protect a power supply apparatus in the drum body that is configured to supply power to the gripping apparatus, the position sensor and the like in the drum body, and ensure the gripping effect, the rotation instruction here is a low-speed rotation instruction, which corresponds to a lower rotating speed than that of the drum in a washing program and a spinning program.

It is to be understood that the main control board may send a rotation stop instruction to the drum driving motor, the drum driving motor returns a rotation stop signal to the main control board, then the main control board immediately turns on the gripping apparatus, and the gripping apparatus enters a working state to grip the clothes inside the drum. This operation considers the fact that during the frequent start and stop process of the drum driving motor, components in the motor will experience significant pressure and is likely to be worn and damaged. For the purpose of protecting the drum driving motor, avoiding wear and damage caused by excessive start and stop to the drum driving motor, and extending the service life of the motor, the main control board may also send a low-speed rotation instruction to the drum driving motor. Because the rotating speed corresponding to the rotation instruction sent by the main control board to the drum driving motor in the automatic clothes hanging program is relatively low, here the low rotating speed in the above step may be maintained, or the rotating speed may be further reduced on this basis. Specifically, it may be set according to the gripping effect in the experiment. The drum driving motor returns a low-speed rotation signal to the main control board, then the main control board immediately turns on the gripping apparatus, and the gripping apparatus enters a working state to grip the clothes inside the drum.

In S2: The main control board sends a gripping instruction to the gripping apparatus, so that the gripping apparatus grips the clothes inside the drum. At this time, in response to the gripping instruction, the gripping apparatus grips the clothes inside the drum and then maintains a gripping state.

In S3: The main control board sends a rotation instruction to the drum driving motor, so that the drum driving motor drives the drum to rotate until the gripping apparatus is at the highest point, and the clothes are hung vertically under the action of gravity at this time, completing automatic clothes hanging. The highest point is obtained through the position detection module. Specifically, it is obtained by that the main control board detects a signal fed back from the position detection module.

In this embodiment, a laundry program of the washing machine includes, but not limited to, a washing program, a spinning program, an automatic clothes hanging program, a drying program, a sterilization program, an aroma care program, etc. After the washing and spinning programs for the clothes is completed in the drum of the washing machine, the automatic clothes hanging program may start first for hanging the clothes, followed by treatment such as drying, sterilization, aroma care, fresh air, clothes warming, and plasma treatment. Alternatively, drying treatment may be performed first and then the automatic clothes hanging program starts for hanging the clothes, followed by treatment such as sterilization, aroma care, fresh air, clothes warming, and plasma treatment. The specific execution sequence of the laundry program may be adaptively adjusted according to the actual use scenarios and needs.

In this embodiment, the position detection module is a position sensor or a drum driving motor. When the position sensor is used to detect the position information of the gripping apparatus, the gripping apparatus and the position sensor may be arranged between the drum rib and an inner wall of the drum, and the position sensor can continuously transmit the current position information of the gripping apparatus to the main control board. The main control board determines whether the gripping apparatus reaches the lowest point or highest point according to the position information of the gripping apparatus transmitted by the position sensor. When the drum driving motor is used to detect the position information of the gripping apparatus, a corresponding relationship between an initial rotation position of the drum driving motor and a position of the gripping apparatus is established first, and then the main control board determines whether the gripping apparatus reaches the lowest point or highest point through the motor rotation information transmitted by the drum driving motor.

It is to be understood that in this embodiment, the lowest point does not refer to a physical lowest point of the drum, but to a point at which, during the rotation of the drum driven by the drum driving motor, the clothes are carried to a height by the protruding drum rib in the drum, and naturally fall down under the action of gravity, and fall onto the wall of the drum. Therefore, in this embodiment, the lowest point does not specifically refer to a certain point, but generally refers to all points at which the clothes are carried to a height by the protruding drum rib in the drum, naturally fall down under the action of gravity, and fall onto the wall of the drum. A set of these points may form a gripping area. The gripping area may be obtained by establishing a washing machine simulation model to simulate the washing process of clothes and analyze the force on the clothes, that is, the clothes are subjected to the vertical downward gravity G, the frictional force f of the wall of the drum, and the elastic force N, thus obtaining an area formed by positions where the clothes fall onto the wall of the drum. The gripping area may also be obtained by conducting experiments on spun clothes of different materials, weights and the like, recording positions where the clothes fall onto the wall of the drum, and forming empirical values.

In this embodiment, the highest point does not refer to a physical highest point of the drum, but rather to a point at which, during the rotation of the drum driven by the drum driving motor, the clothes are gripped by the gripping apparatus to rotate together, the clothes gripped by the gripping apparatus are carried to a height by the drum, and the clothes are vertically hung under the action of gravity. Therefore, in this embodiment, the highest point does not refer to a specific point, but generally refers to all points at which the clothes gripped by the gripping apparatus are carried to a height by the drum, and the clothes are vertically hung under the action of gravity. A set of these points may form a hanging area. The hanging area may be obtained by establishing a washing machine simulation model to simulate the washing process of clothes and analyze the force on the clothes, that is, the clothes are subjected to the vertical downward gravity G, the frictional force f of the wall of the drum, and the elastic force N, thus obtaining an area formed by positions where the clothes can be vertically hung in the drum. The hanging area may also be obtained by conducting experiments on spun clothes of different materials, weights and the like, recording the positions where the clothes can be vertically hung in the drum, and forming empirical values.

In order to improve the coincidence between the time when the clothes fall onto the wall of the drum and the time when the gripping apparatus is located in the gripping area, reduce the error of a single gripping operation, and ensure the gripping effect, the gripping process is optimized. Through the cooperation with the rotation of the drum body, the clothes are attached to the drum rib provided with the gripping apparatus. For the clothes that have already been gripped, adding a release action can not only release them but also adjust the position where the clothes are gripped; for the gripping apparatus that does not grip any clothes in a previous gripping process, gripping is achieved through a subsequent gripping action.

Referring to FIG. 9, in some embodiments, after the main control board sends a rotation instruction to the drum driving motor, so that the drum driving motor drives the drum to rotate until the gripping apparatus is at the highest point, the laundry control method further includes the following step:

In S4: The main control board sends a release instruction to the gripping apparatus; the process returns to step S1 in which the main control board sends a rotation instruction to the drum driving motor, so that the drum driving motor drives the drum to rotate until the gripping apparatus is at the lowest point; and gripping is continued, that is, the main control board sends a gripping instruction to the gripping apparatus, so that the gripping apparatus grips the clothes inside the drum. At this time, in response to the gripping instruction, the gripping apparatus grips the clothes inside the drum and then maintains a gripping state. Then, the main control board sends a rotation instruction to the drum driving motor, so that the drum driving motor drives the drum to rotate until the gripping apparatus is at the highest point, and the clothes are hung vertically under the action of gravity at this time, completing automatic clothes hanging.

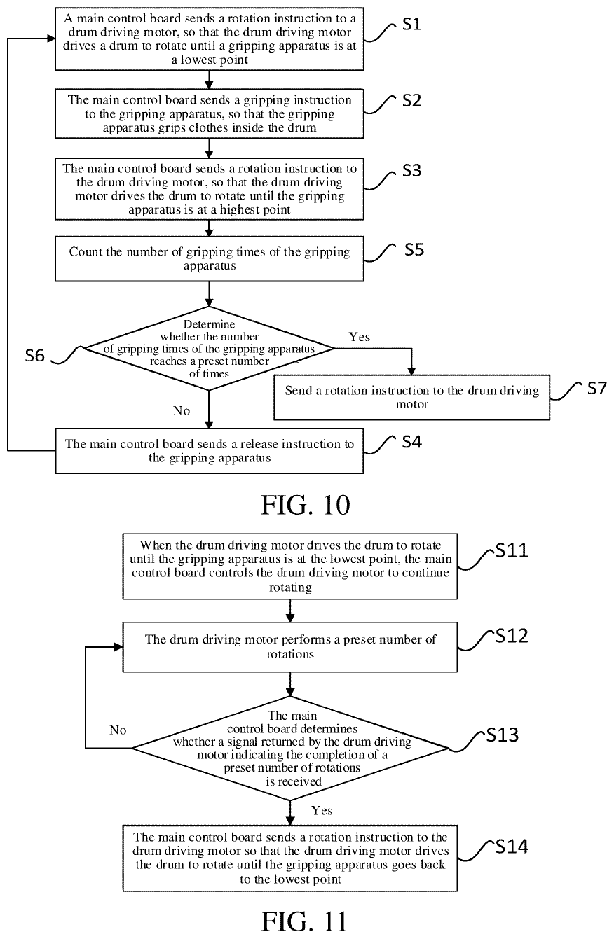

Since the random errors of multiple gripping results follow a normal distribution, in order to further ensure the gripping effect, referring to FIG. 10, in some embodiments, before step S4 in which the main control board sends a release instruction to the gripping apparatus, the laundry control method further includes the following steps:

In S5: The main control board counts the number of gripping times of the gripping apparatus.

In S6: The main control board determines whether the number of gripping times of the gripping apparatus reaches a preset number of times.

In S4: if the main control board determines that the number of gripping times of the gripping apparatus does not reach the preset number of times, the main control board sends the release instruction to the gripping apparatus; the process returns to step S1 in which the main control board sends a rotation instruction to the drum driving motor, so that the drum driving motor drives the drum to rotate until the gripping apparatus is at the lowest point; and gripping is continued. In this embodiment, the preset number of times is set to N, and the main control board counts from the first gripping of the gripping apparatus (that is, i=1). If i≠N, a release instruction is sent to the gripping apparatus; the process returns to step S1 in which the main control board sends a rotation instruction to the drum driving motor, so that the drum driving motor drives the drum to rotate until the gripping apparatus is at the lowest point; gripping is continued, and then if the main control board detects that the gripping apparatus reaches the hanging area again, the number of gripping times of the gripping apparatus is counted as i, where i=2 at this time; and the above steps are repeated until the number of gripping times of the gripping apparatus reaches the preset number of times.

In S7: If the main control board determines that the number of gripping times of the gripping apparatus reaches the preset number of times, a rotation stop instruction is sent to the drum driving motor.

In order to improve the coincidence between the time when the clothes fall onto the wall of the drum and the time when the gripping apparatus is located in the gripping area, reduce the position deviation of the clothes on the wall of the drum, and ensure the gripping effect, referring to FIG. 11, in some embodiments, the step that the main control board sends a rotation instruction to the drum driving motor, so that the drum driving motor drives the drum to rotate until the gripping apparatus is at the lowest point further includes the following steps:

In S11: When the drum driving motor drives the drum to rotate until the gripping apparatus is at the lowest point, the main control board controls the drum driving motor to continue rotating.

In S12: The drum driving motor performs a preset number of rotations. For example, the main control board controls the drum driving motor to continue rotating for one turn, and then the clothes gripping operation is performed.

In S13: The main control board determines whether a signal returned by the drum driving motor indicating the completion of a preset number of rotations is received.

In S14: When the main control board receives the signal returned by the drum driving motor indicating the completion of a preset number of rotations, the main control board sends a rotation instruction to the drum driving motor, so that the drum driving motor drives the drum to rotate until the gripping apparatus goes back to the lowest point. The lowest point at this time and the lowest point in step S11 above may be the same point in the gripping area, or may be different points in the gripping area.

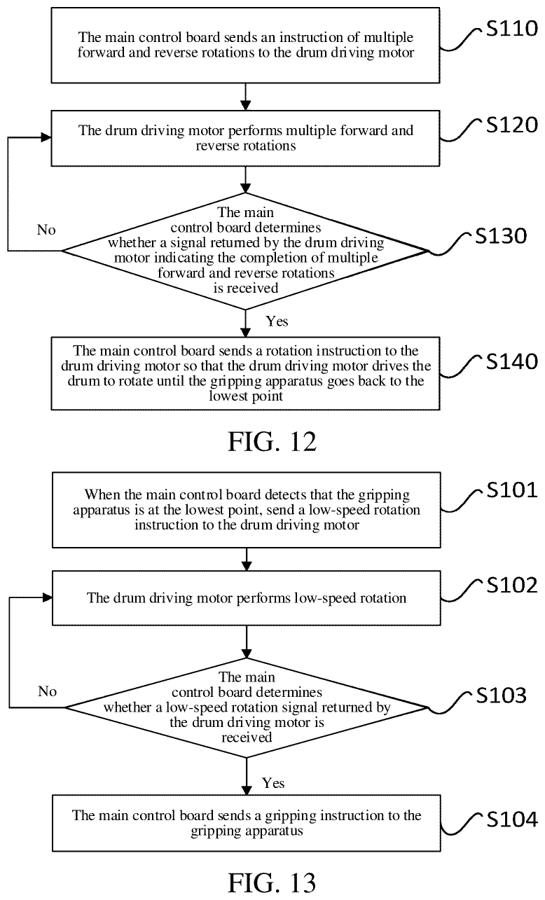

In order to ensure the gripping effect, referring to FIG. 12, in some embodiments, the step that the main control board sends a rotation instruction to the drum driving motor, so that the drum driving motor drives the drum to rotate until the gripping apparatus is at the lowest point further includes the following steps:

In S110: The main control board sends an instruction of multiple repeated forward and reverse rotations to the drum driving motor.

In S120: The drum driving motor performs multiple forward and reverse rotations. In the process that the motor drives the clothes to move up and down, the clothes are likely to become untangled, which helps prevent entanglement. This facilitates the gripping of the gripping apparatus, and ensure the gripping effect.

In S130: The main control board determines whether a signal returned by the drum driving motor indicating the completion of multiple forward and reverse rotations is received.

In S140: After the main control board receives the signal returned by the drum driving motor indicating the completion of multiple forward and reverse rotations, the main control board sends a rotation instruction to the drum driving motor, so that the drum driving motor drives the drum to rotate until the gripping apparatus goes back to the lowest point. The lowest point at this time and the lowest point in step S110 above may be the same point in the gripping area, or may be different points in the gripping area.

To ensure the gripping effect and simultaneously avoid wear and damage caused by excessive start and stop to the drum driving motor, sufficient gripping time is reserved for the gripping apparatus. Referring to FIG. 13, in some embodiments, the step that the main control board sends a rotation instruction to the drum driving motor, so that the drum driving motor drives the drum to rotate until the gripping apparatus is at the lowest point further includes the following steps:

S101: When the main control board detects that the gripping apparatus is at the lowest point, a low-speed rotation instruction is sent to the drum driving motor. This operation considers the fact that during the frequent start and stop process of the drum driving motor, components in the motor will experience significant pressure and is likely to be worn and damaged, and is for the purpose of protecting the drum driving motor, avoiding wear and damage caused by excessive start and stop to the drum driving motor, and extending the service life of the motor. Because the rotating speed corresponding to the rotation instruction sent by the main control board to the drum driving motor in the automatic clothes hanging program is relatively low, here the low rotating speed in the above step may be maintained, or the rotating speed may be further reduced on this basis. The specific rotating speed may be specifically set according to the gripping effect in the experiment.

In S102: The drum driving motor performs low-speed rotation.

In S103, the main control board determines whether a low-speed rotation signal returned by the drum driving motor is received.

In S104: If the main control board receives the low-speed rotation signal returned by the drum driving motor, a gripping instruction is sent to the gripping apparatus, so that the gripping apparatus enters a working state and grips the clothes inside the drum.

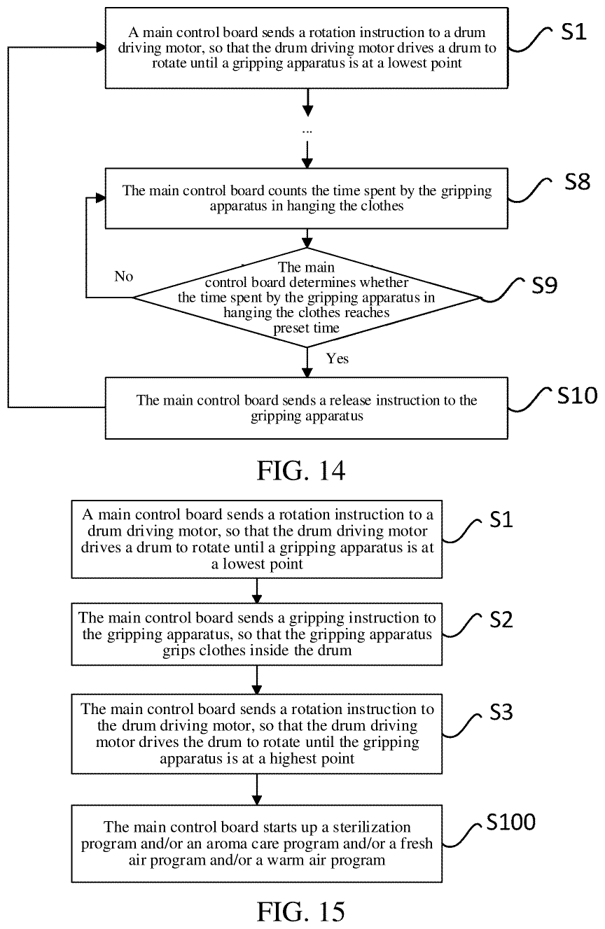

Since there may be the situation that it is difficult to dry the part of the clothes gripped by the gripping apparatus, in order to grip the clothes from a different angle to fully dry the clothes, and improve the user experience, referring to FIG. 14, in some embodiments, after the main control board sends a rotation instruction to the drum driving motor, so that the drum driving motor drives the drum to rotate until the gripping apparatus is at the highest point, the laundry control method further includes the following steps:

In S8: The main control board counts the time spent by the gripping apparatus in hanging the clothes.

In S9: The main control board determines whether the time spent by the gripping apparatus in hanging the clothes reaches preset time.

In S10: If the main control board detects that the time spent by the gripping apparatus in hanging the clothes reaches the preset time, a release instruction is sent to the gripping apparatus. In some embodiments, in order to improve the user experience, after a release instruction is sent to the gripping apparatus, the laundry control method further includes the following steps: the process returns to step S1 in which the main control board sends a rotation instruction to the drum driving motor, so that the drum driving motor drives the drum to rotate until the gripping apparatus is at the lowest point; and gripping is continued to grip the clothes again from a different angle to fully dry the clothes.

Referring to FIG. 1, in some embodiments, the automatic clothes hanging program is executed before starting a drying program, or the automatic clothes hanging program is executed in the drying program. For example, after the automatic clothes hanging program is completed, the main control board sends an instruction to start up the drying program. The main control board sends an instruction to turn on a heating apparatus and a fan of the drying assembly, and simultaneously turn on the humidity sensor and/or the temperature sensor. That is, one of a separate temperature sensor, a separate humidity sensor, and a combination of a temperature sensor and a humidity sensor may be adopted to detect whether the clothes have been dried. The sensors continuously return temperature and/or humidity values to the main control board. If the temperature and/or humidity values returned by the sensors are continuously less than set values for n minutes, the main control board determines that the clothes have been dried, and turns off the drying assembly. At this time, the sterilization and drying program is completed once. Alternatively, after the washing machine completes the rinsing and spinning programs, the clothes are still damp after being spun. At this time, the washing machine starts the drying program and executes the automatic clothes hanging program in the drying program. In the drying process, the heating apparatus and the fan of the drying assembly are also turned on, and the humidity sensor and/or temperature sensor are simultaneously turned on. Here, one of a separate temperature sensor, a separate humidity sensor, and a combination of a temperature sensor and a humidity sensor may be adopted to detect whether the clothes have been dried. The sensors continuously return temperature and/or humidity values to the main control board. If the temperature and/or humidity values returned by the sensors are continuously less than set values for n minutes, the main control board determines that the clothes have been dried, and turns off the drying assembly. At this time, the sterilization and drying program is completed once.

In some embodiments, the drying program includes at least one automatic clothes hanging program, and the drying program ends until it is detected that temperature and/or humidity values inside the drum are lower than set values within preset time. This is applicable to the situation where the automatic clothes hanging program is executed before starting the drying program, or the automatic clothes hanging program is executed in the drying program. If the automatic clothes hanging program is executed before starting the drying program, since there may be the situation that it is difficult to dry the part of the clothes gripped by the gripping apparatus in the drying process, in order to grip the clothes from a different angle to fully dry the clothes, at least one automatic clothes hanging program may be executed in the drying program. If the automatic clothes hanging program is executed in the drying program, in order to improve the drying efficiency, the clothes may be hung for drying; or in order to avoid the problem that it is difficult to dry the part of the clothes gripped by the gripping apparatus, and in order to grip the clothes from a different angle to fully dry the clothes, at least one automatic clothes hanging program may be executed in the drying program.

In some embodiments, the drying program further includes a sterilization program and/or an aroma care program. Regardless of whether the automatic clothes hanging program is executed before starting the drying program, or the automatic clothes hanging program is executed in the drying program, in the drying process, the clothes are always in a state of being gripped and hung by the gripping apparatus, and the area of the clothes that is exposed to and/or in contact with a sterilization apparatus and/or an aroma care apparatus greatly increases. During drying, the area of contact between the clothes and hot air also greatly increases, making the sterilization effect and/or aroma care effect much better than that of the clothes that are clumped together and are not hung, and also making the air-drying speed of the clothes much faster than that of the clothes which are clumped together. The sterilization apparatus includes, but not limited to, any one of ultraviolet lamp, high temperature, ozone, silver ions, and the like.

After the drying program is completed once, if the user does not take out the clothes in a timely manner and causes moisture regain, the drying program will be repeated for a second time. Further, after the drying program ends, if a door of a washing machine is not opened within preset time, a new round of drying program automatically starts. At this time, the main control board sends an instruction to start up the drying program, turn on the heating wire and the fan of the drying assembly, and simultaneously turn on the humidity sensor and/or temperature sensor. The sensors continuously return the temperature and/or humidity values to the main control board. If the temperature and/or humidity values are less than the set values for n minutes again, the user may open the door of the washing machine, completing the entire laundry program.

In some embodiments, the automatic clothes hanging program is executed after the drying program is completed. That is, after the drying program is completed, the main control board sends an instruction to start up the automatic clothes hanging program.

Referring to FIG. 15, after the main control board sends a rotation instruction to the drum driving motor, so that the drum driving motor drives the drum to rotate until the gripping apparatus is at the highest point, the laundry control method further includes the following step:

In S100: The main control board starts up a sterilization program and/or an aroma care program and/or a fresh air program and/or a warm air program and/or a plasma program. After the clothes are dried, clothes hanging is achieved through the automatic clothes hanging control method described above. The clothes are gripped and hung by the gripping apparatus. At this time, the sterilization program and/or aroma care program and/or fresh air program and/or warm air program and/or plasma program are started up, and the area of the clothes that is exposed to and/or in contact with the sterilization apparatus and/or aroma care apparatus and/or fresh air apparatus and/or warm air apparatus and/or plasma apparatus greatly increases, thus making the sterilization effect and/or aroma care effect and/or fresh air effect and/or warm air effect and/or plasma effect much better than that of the clothes which are clumped together and are not hung.

It is to be understood that by executing the sterilization program after hanging the clothes, the clothes can be sterilized from multiple angles, thus effectively reducing the sterilization time and improving the sterilization effect. The program may also be configured in the clothes hanging program and executed according to the environment inside the drum or the user needs. Correspondingly, by executing the aroma care program after hanging the clothes, the clothes can be refreshed with aroma from multiple angles. Aroma molecules are evenly attached to the inner and outer surfaces of the hung clothes, thus improving the aroma care effect and reducing the aroma care time. The program may also be configured in the clothes hanging program and executed according to the user choices or needs. Similarly, by executing the fresh air program and/or the warm air program after hanging the clothes, the clothes can be cared for with fresh air or warm air when the clothes are in a hanging state, thus preventing the washed clothes from having an odor or raising the temperature of the clothes so that the clothes can be immediately worn. The program may also be configured in the clothes hanging program and executed according to user choices or needs. Similarly, by executing the plasma program after hanging the clothes, the clothes can be cared for with plasmas when the clothes are in a hanging state, thus sterilizing the clothes inside the drum to prevent the washed clothes from having an odor. The program may also be configured in the clothes hanging program and executed according to user choices or needs.

In this embodiment, the gripping apparatus and the position sensor are both supplied with power by a power supply apparatus in the drum body. A power supply circuit may be in a continuously conducted state or only conducted during the execution of the clothes hanging program. For example, in the washing program, spinning program and other programs of the laundry program, the motor rotates at high speed. In order to avoid damage to the power supply apparatus in the drum body when the motor rotates at high speed, the power supply apparatus in the drum body does not supply power to the gripping apparatus and the position sensor inside the drum in the laundry program corresponding to the high speed rotation of the motor. In the automatic clothes hanging program, the motor rotates at low speed, the power supply apparatus in the drum body supplies power to the gripping apparatus, the position sensor, and the like inside the drum. In some embodiments, the laundry control method further includes the following step: the main control board sends an automatic clothes hanging instruction to control the power supply circuit of the gripping apparatus to be conducted.

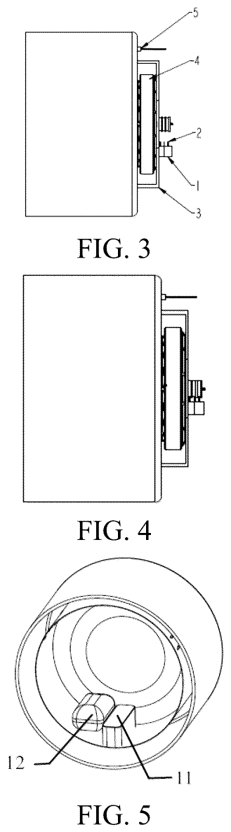

FIG. 2, FIG. 3, and FIG. 4 show an implementation of the power supply apparatus in the drum body. The power supply apparatus in the drum body includes a contact motor and a metal conductive rod. The metal conductive rod is fixed onto the contact motor. The conductive ring is electrically connected to the gripping apparatus and the position sensor. The contact motor is configured to move a preset distance towards the conductive ring in response to the automatic clothes hanging instruction sent by the main control board, and feed back a displacement signal to the main control board. After the contact motor moves the preset distance towards the conductive ring, the metal conductive rod on the contact motor is in contact with the conductive ring. In this embodiment, several wires are provided on an outer end of the conductive ring. The wires pass through a center hole of the conductive ring, enter an axial hole of the tripod, and then exit from the other end of the tripod to reach the area between tub and the drum of the washing machine. The wires are connected to the gripping apparatus in the drum rib to supply power to it. In the washing program, spinning program and other programs of the laundry program, the motor rotates at high speed. In order to avoid damage to the power supply apparatus in the drum body when the motor rotates at high speed, the power supply apparatus in the drum body does not supply power to the gripping apparatus and the position sensor inside the drum in the laundry program corresponding to the high speed rotation of the motor. In the automatic clothes hanging program, the motor rotates at low speed, the power supply apparatus in the drum body supplies power to the gripping apparatus, the position sensor, and the like inside the drum.

A control method for the power supply apparatus in the drum body shown in FIG. 2, FIG. 3 and FIG. 4 includes the following steps:

In the automatic clothes hanging program, the main control board sends an automatic clothes hanging instruction to control the contact motor to move a preset distance towards the conductive ring. At this time, the contact motor moves towards the conductive ring. After the contact motor completes the displacement of the preset distance, the metal conductive rod on the contact motor and the conductive ring establish circuit conduction, the gripping apparatus, the position sensor, and the like mounted inside the drum are powered on and in a standby state, the contact motor feeds back a displacement signal to the main control board, and the main control board controls the drum driving motor to rotate clockwise/anticlockwise at low speed.

### Embodiment 4

This embodiment provides a laundry apparatus capable of automatically hanging clothes, which is configured to implement the laundry control method capable of automatically hanging clothes in Embodiment 3. Regarding the detailed description thereof, please refer to the corresponding description in the method embodiment, which will not be repeated here.

Referring to FIG. 2, the laundry apparatus is provided with a tub, a drum, a drum driving apparatus, and a main control board. The drum is provided with a gripping apparatus and a position sensor, where the gripping apparatus is configured to grip clothes inside the drum, the gripping apparatus has a highest point and a lowest point in a vertical direction when rotating with the drum, and the position sensor is configured to send current position information of the gripping apparatus to the main control board. The drum driving apparatus includes, but not limited to, a belt pulley driven by a motor, a direct driving motor, or the like. In this embodiment, the drum driving apparatus is a drum driving motor.

The main control board is configured to send a control instruction to the drum driving motor, determine whether the gripping apparatus reaches a gripping area/hanging area according to the position information of the gripping apparatus, send a gripping instruction to the gripping apparatus if the gripping apparatus reaches the gripping area, and send a rotation stop instruction to the drum driving motor if the gripping apparatus reaches the hanging area. The drum driving motor is configured to control the drum in response to the control instruction sent by the main control board.

The gripping apparatus is configured to grip/release clothes inside the drum in response to the control instruction sent by the main control board. It is to be understood that the gripping apparatus may also be represented as a picking apparatus, a grasping apparatus, or a clamping apparatus, which is configured to achieve the detachment or partial detachment of the clothes to be cleaned (especially underwear) from the contact with a wall of the drum under the action of gravity.

In this embodiment, a laundry program of the washing machine includes, but not limited to, a washing program, a spinning program, an automatic clothes hanging program, a drying program, a sterilization program, an aroma care program, etc. After the washing and spinning programs of the clothes is completed in the drum of the washing machine, the automatic clothes hanging program may start first for hanging the clothes, followed by treatment such as drying, sterilization, aroma care, fresh air care, warm air care, and plasma care. Alternatively, drying treatment may be performed first and then the automatic clothes hanging program starts for hanging the clothes, followed by treatment such as sterilization, aroma care, fresh air care, warm air care, and plasma care. The specific execution sequence of the laundry program may be adaptively adjusted according to the actual use scenarios and needs.

In some embodiments, the gripping apparatus includes at least one pair of grippers configured to grip multiple pieces of clothes.

In some embodiments, the drum of the laundry apparatus is further provided with a sterilization apparatus and/or an aroma care apparatus, a drying apparatus, and any one or two of a temperature sensor and a humidity sensor. The laundry apparatus may also be provided with a fresh air apparatus, a warm air apparatus, and a plasma apparatus to care the dried clothes.

Referring to FIG. 1, in some embodiments, the automatic clothes hanging program is executed before starting a drying program, or the automatic clothes hanging program is executed in the drying program. For example, after the automatic clothes hanging program is completed, the main control board sends an instruction to start up the drying program. The main control board sends an instruction to turn on a heating apparatus and a fan of the drying assembly, and simultaneously turn on the humidity sensor and/or the temperature sensor. That is, one of a separate temperature sensor, a separate humidity sensor, and a combination of a temperature sensor and a humidity sensor may be adopted to detect whether the clothes have been dried. The sensors continuously return temperature and/or humidity values to the main control board. If the temperature and/or humidity values returned by the sensors are continuously less than set values for n minutes, the main control board determines that the clothes have been dried, and turns off the drying assembly. At this time, the sterilization and drying program is completed once. Alternatively, after the washing machine completes the rinsing and spinning programs, the clothes are still damp after being spun. At this time, the washing machine starts the drying program and executes the automatic clothes hanging program in the drying program. In the drying process, the heating apparatus and the fan of the drying assembly are also turned on, and the humidity sensor and/or temperature sensor are simultaneously turned on. Here, one of a separate temperature sensor, a separate humidity sensor, and a combination of a temperature sensor and a humidity sensor may be adopted to detect whether the clothes have been dried. The sensors continuously return temperature and/or humidity values to the main control board. If the temperature and/or humidity values returned by the sensors are continuously less than set values for n minutes, the main control board determines that the clothes have been dried, and turns off the drying assembly. At this time, the sterilization and drying program is completed once.

In some embodiments, the drying program includes at least one automatic clothes hanging program, and the drying program ends until it is detected that temperature and/or humidity values inside the drum are lower than set values within preset time. This is applicable to the situation where the automatic clothes hanging program is executed before starting the drying program, or the automatic clothes hanging program is executed in the drying program. If the automatic clothes hanging program is executed before starting the drying program, since there may be the situation that it is difficult to dry the part of the clothes gripped by the gripping apparatus in the drying process, in order to grip the clothes from a different angle to fully dry the clothes, at least one automatic clothes hanging program may be executed in the drying program. If the automatic clothes hanging program is executed in the drying program, in order to improve the drying efficiency, the clothes may be hung for drying; or in order to avoid the problem that it is difficult to dry the part of the clothes gripped by the gripping apparatus, and in order to grip the clothes from a different angle to fully dry the clothes, at least one automatic clothes hanging program may be executed in the drying program.

In some embodiments, the drying program further includes a sterilization program and/or an aroma care program. Regardless of whether the automatic clothes hanging program is executed before starting the drying program, or the automatic clothes hanging program is executed in the drying program, in the drying process, the clothes are always in a state of being gripped and hung by the gripping apparatus, and the area of the clothes that is exposed to and/or in contact with a sterilization apparatus and/or an aroma care apparatus greatly increases. During drying, the area of contact between the clothes and hot air also greatly increases, making the sterilization effect and/or aroma care effect much better than that of the clothes that are clumped together and are not hung, and also making the air-drying speed of the clothes much faster than that of the clothes which are clumped together. The sterilization apparatus includes, but not limited to, any one of ultraviolet lamp, high temperature, ozone, silver ions, and the like.

After the drying program is completed once, if the user does not take out the clothes in a timely manner and causes moisture regain, the drying program will be repeated for a second time. Further, after the drying program ends, if a door of a washing machine is not opened within preset time, a new round of drying program automatically starts. At this time, the main control board sends an instruction to start up the drying program, turn on the heating wire and the fan of the drying assembly, and simultaneously turn on the humidity sensor and/or temperature sensor. The sensors continuously return the temperature and/or humidity values to the main control board. If the temperature and/or humidity values are less than the set values for n minutes again, the user may open the door of the washing machine, completing the entire laundry program.

In some embodiments, the automatic clothes hanging program is executed after the drying program is completed. That is, after the drying program is completed, the main control board sends an instruction to start up the automatic clothes hanging program.

After the main control board sends a rotation instruction to the drum driving motor, so that the drum driving motor drives the drum to rotate until the gripping apparatus is at the highest point, the laundry control method further includes the following step:
the main control board starts up a sterilization program and/or an aroma care program and/or a fresh air program and/or a warm air program and/or a plasma program. After the clothes are dried, clothes hanging is achieved through the automatic clothes hanging control method described above. The clothes are gripped and hung by the gripping apparatus. At this time, the sterilization program and/or aroma care program and/or fresh air program and/or warm air program and/or plasma program are started up, and the area of the clothes that is exposed to and/or in contact with the sterilization apparatus and/or aroma care apparatus and/or fresh air apparatus and/or warm air apparatus and/or plasma apparatus greatly increases, thus making the sterilization effect and/or aroma care effect and/or fresh air effect and/or warm air effect and/or plasma effect much better than that of the clothes which are clumped together and are not hung.

It is to be understood that by executing the sterilization program after hanging the clothes, the clothes can be sterilized from multiple angles, thus effectively reducing the sterilization time and improving the sterilization effect. The program may also be configured in the clothes hanging program and executed according to the environment inside the drum or the user needs. Correspondingly, by executing the aroma care program after hanging the clothes, the clothes can be refreshed with aroma from multiple angles. Aroma molecules are evenly attached to the inner and outer surfaces of the hung clothes, thus improving the aroma care effect and reducing the aroma care time. The program may also be configured in the clothes hanging program and executed according to the user choices or needs. Similarly, by executing the fresh air program and/or the warm air program after hanging the clothes, the clothes can be cared for with fresh air or warm air when the clothes are in a hanging state, thus preventing the washed clothes from having an odor or raising the temperature of the clothes so that the clothes can be immediately worn. The program may also be configured in the clothes hanging program and executed according to user choices or needs. Similarly, by executing the plasma program after hanging the clothes, the clothes can be cared for with plasmas when the clothes are in a hanging state, thus sterilizing the clothes inside the drum to prevent the washed clothes from having an odor. The program may also be configured in the clothes hanging program and executed according to user choices or needs.

In this embodiment, the gripping apparatus and the position sensor are both supplied with power by a power supply apparatus in the drum body. A power supply circuit may be in a continuously conducted state or only conducted during the execution of the clothes hanging program. For example, in the washing program, spinning program and other programs of the laundry program, the motor rotates at high speed. In order to avoid damage to the power supply apparatus in the drum body when the motor rotates at high speed, the power supply apparatus in the drum body does not supply power to the gripping apparatus and the position sensor inside the drum in the laundry program corresponding to the high speed rotation of the motor. In the automatic clothes hanging program, the motor rotates at low speed, the power supply apparatus in the drum body supplies power to the gripping apparatus, the position sensor, and the like inside the drum.

FIG. 2, FIG. 3, and FIG. 4 show an implementation of the power supply apparatus in the drum body. The power supply apparatus in the drum body includes a contact motor and a metal conductive rod. The metal conductive rod is fixed on the contact motor. The conductive ring is electrically connected with the gripping apparatus and the position sensor. The contact motor is configured to move a preset distance towards the conductive ring in response to the automatic clothes hanging instruction sent by the main control board, and feed back a displacement signal to the main control board. After the contact motor moves the preset distance towards the conductive ring, the metal conductive rod on the contact motor is in contact with the conductive ring. In this embodiment, several wires are provided on an outer end of the conductive ring. The wires pass through a center hole of the conductive ring, enter an axial hole of the tripod, and then exit from the other end of the tripod to reach the area between tub and the drum of the washing machine. The wires are connected to the gripping apparatus in the drum rib to supply power to it. In the washing program, spinning program and other programs of the laundry program, the motor rotates at high speed. In order to avoid damage to the power supply apparatus in the drum body when the motor rotates at high speed, the power supply apparatus in the drum body does not supply power to the gripping apparatus and the position sensor inside the drum in the laundry program corresponding to the high speed rotation of the motor. In the automatic clothes hanging program, the motor rotates at low speed, the power supply apparatus in the drum body supplies power to the gripping apparatus, the position sensor, and the like inside the drum.

Example: in this example, the cold water temperature for soaking clothes is set to (15±2)° C., the ambient temperature is set to (25±2)° C., and the ambient humidity is set to (55±5)%, an exhaust type drum washing and drying machine is adopted, the heater power is 1200 W, the cross-sectional area of an air outlet of a drying passage is 2314mm², and the speed of a fan is 2600 RPM. A standard load cloth is adopted, which is spun to a moisture content of 85%. The initial humidity in a drum is greater than or equal to 95% RH. The same exhaust type drum washing and drying machine is used to dry the same standard load cloth. One standard cloth is dried in a standard mode. That is, the clothes are dried through a drying program after spinning. The other standard cloth is dried after hanging. Comparison is made between the drying durations of the two. Referring to FIG. 7, it can be seen that the humidity decreases faster in case of drying by hanging and tends to gentle after about 25 min, reaching a dry state, while in the standard drying mode, it takes 45-50 min to reach dryness, indicating that the speed of drying by hanging is significantly faster than the standard drying speed.

What are described above are just exemplary embodiments of the present disclosure. It is to be pointed that those skilled in the art may make several improvements and modifications without departing from the principle of the present disclosure, which, however, still fall within the scope of protection of the present disclosure.

1-22. (canceled)

23. A laundry control method capable of automatically hanging clothes, applied to a laundry apparatus, the laundry apparatus being provided with a tub, a drum, a drum driving motor, and a main control board, the drum being provided with a gripping apparatus, the gripping apparatus having a highest point and a lowest point in a vertical direction when rotating with the drum, the gripping apparatus being provided with a position detection module;
the laundry control method comprising a clothes hanging program, the clothes hanging program comprising the following steps:
sending, by the main control board, a rotation instruction to the drum driving motor, so that the drum driving motor drives the drum to rotate until the gripping apparatus is at the lowest point, and clothes fall onto a wall of the drum under the action of gravity, wherein the lowest point is obtained through the position detection module;
sending, by the main control board, a gripping instruction to the gripping apparatus, so that the gripping apparatus grips the clothes inside the drum; and
sending, by the main control board, a rotation instruction to the drum driving motor, so that the drum driving motor drives the drum to rotate until the gripping apparatus is at the highest point, and the clothes are hung vertically under the action of gravity at this time, completing automatic clothes hanging, wherein the highest point is obtained through the position detection module.

24. The laundry control method capable of automatically hanging clothes according to claim 23, wherein after the step of sending, by the main control board, a rotation instruction to the drum driving motor, so that the drum driving motor drives the drum to rotate until the gripping apparatus is at the highest point, the laundry control method further comprises the following steps:
sending, by the main control board, a release instruction to the gripping apparatus; returning to the step of sending, by the main control board, a rotation instruction to the drum driving motor, so that the drum driving motor drives the drum to rotate until the gripping apparatus is at the lowest point; and continuing to perform gripping.

25. The laundry control method capable of automatically hanging clothes according to claim 24, wherein before the step of sending, by the main control board, a release instruction to the gripping apparatus, the laundry control method further comprises the following steps:
counting, by the main control board, the number of gripping times of the gripping apparatus;
determining, by the main control board, whether the number of gripping times of the gripping apparatus reaches a preset number of times;
if the main control board determines that the number of gripping times of the gripping apparatus does not reach the preset number of times, sending, by the main control board, a release instruction to the gripping apparatus; returning to the step of sending, by the main control board, a rotation instruction to the drum driving motor, so that the drum driving motor drives the drum to rotate until the gripping apparatus is at the lowest point; continuing to perform gripping; and
if the main control board determines that the number of gripping times of the gripping apparatus reaches the preset number of times, sending a rotation stop instruction to the drum driving motor.

26. The laundry control method capable of automatically hanging clothes according to claim 23, wherein the step of sending, by the main control board, a rotation instruction to the drum driving motor, so that the drum driving motor drives the drum to rotate until the gripping apparatus is at the lowest point further comprises the following steps:
when the drum driving motor drives the drum to rotate until the gripping apparatus is at the lowest point, controlling, by the main control board, the drum driving motor to continue rotating; and
when the main control board receives a signal returned by the drum driving motor indicating the completion of a preset number of rotations, sending, by the main control board, a rotation instruction to the drum driving motor, so that the drum driving motor drives the drum to rotate until the gripping apparatus goes back to the lowest point.

27. The laundry control method capable of automatically hanging clothes according to claim 23, wherein the step of sending, by the main control board, a rotation instruction to the drum driving motor, so that the drum driving motor drives the drum to rotate until the gripping apparatus is at the lowest point further comprises the following steps:
sending, by the main control board, an instruction of multiple forward and reverse rotations to the drum driving motor; and
after the main control board receives a signal returned by the drum driving motor indicating the completion of multiple forward and reverse rotations, sending, by the main control board, a rotation instruction to the drum driving motor, so that the drum driving motor drives the drum to rotate until the gripping apparatus goes back to the lowest point.

28. The laundry control method capable of automatically hanging clothes according to claim 23, wherein the step of sending, by the main control board, a rotation instruction to the drum driving motor, so that the drum driving motor drives the drum to rotate until the gripping apparatus is at the lowest point further comprises the following steps:
when the main control board detects that the gripping apparatus is at the lowest point, sending a low-speed rotation instruction to the drum driving motor; and
if the main control board receives a low-speed rotation signal returned by the drum driving motor, sending a gripping instruction to the gripping apparatus.

29. The laundry control method capable of automatically hanging clothes according to claim 23, wherein after the step of sending, by the main control board, a rotation instruction to the drum driving motor, so that the drum driving motor drives the drum to rotate until the gripping apparatus is at the highest point, the laundry control method further comprises the following steps:
counting, by the main control board, the time spent by the gripping apparatus in hanging the clothes; and
if the main control board detects that the time spent by the gripping apparatus in hanging the clothes reaches preset time, sending a release instruction to the gripping apparatus.

30. The laundry control method capable of automatically hanging clothes according to claim 29, wherein after sending a release instruction to the gripping apparatus, the laundry control method further comprises the following steps: returning to the step of sending, by the main control board, a rotation instruction to the drum driving motor, so that the drum driving motor drives the drum to rotate until the gripping apparatus is at the lowest point; and continuing to perform gripping.

31. The laundry control method capable of automatically hanging clothes according to claim 23, wherein the clothes hanging program is executed before entering a drying program, or the clothes hanging program is executed in the drying program.

32. The laundry control method capable of automatically hanging clothes according to claim 31, wherein the drying program comprises at least one clothes hanging program, and the drying program ends until it is detected that temperature and/or humidity inside the drum are lower than set values within preset time.

33. The laundry control method capable of automatically hanging clothes according to claim 31, wherein the drying program further comprises a sterilization program and/or an aroma care program and/or a fresh air program and/or a warm air program.

34. The laundry control method capable of automatically hanging clothes according to claim 23, wherein after the drying program ends, if a door of the washing machine is not opened within preset time, a new round of drying program automatically starts.

35. The laundry control method capable of automatically hanging clothes according to claim 23, wherein the clothes hanging program is executed after a drying program is completed.

36. The laundry control method capable of automatically hanging clothes according to claim 23, wherein after the step of sending, by the main control board, a rotation instruction to the drum driving motor, so that the drum driving motor drives the drum to rotate until the gripping apparatus is at the highest point, the laundry control method further comprises the following step:
starting up, by the main control board, a sterilization program and/or an aroma care program and/or a fresh air program and/or a warm air program and/or a plasma program.

37. The laundry control method capable of automatically hanging clothes according to claim 23, wherein the laundry control method further comprises the following step:
sending, by the main control board, an automatic clothes hanging instruction to control a power supply circuit of the gripping apparatus to be conducted.

38. A laundry apparatus capable of automatically hanging clothes, configured to implement the laundry control method capable of automatically hanging clothes according to claim 23, the laundry apparatus being provided with a tub, a drum, a drum driving motor, and a main control board, the drum being provided with a gripping apparatus and a position sensor, wherein the gripping apparatus is configured to grip clothes inside the drum, the gripping apparatus has a highest point and a lowest point in a vertical direction when rotating with the drum, and the position sensor is configured to send current position information of the gripping apparatus to the main control board.

39. The laundry apparatus capable of automatically hanging clothes according to claim 38, wherein the gripping apparatus comprises at least one pair of grippers.

40. The laundry apparatus capable of automatically hanging clothes according to claim 38, wherein the drum of the laundry apparatus is further provided with a sterilization apparatus and/or an aroma care apparatus, and any one or two of a temperature sensor and a humidity sensor.

41. The laundry apparatus capable of automatically hanging clothes according to claim 38, wherein the drum of the laundry apparatus is provided with a drum rib protruding out of an inner surface wall, and the gripping apparatus is located between the drum rib and an inner wall of the drum.
